(19) United States
(12) Patent Application Publication
(10) Pub. No.: US 2002/0096380 A1
(43) Pub. Date: Jul. 25, 2002

(54) Electric wheel axle drive structure with automatic clutch function

(76) Inventor: Ying-Chou Lai, Hua-Tarn Hsiang (TW)

Correspondence Address: Dougherty & Troxell, ONE SKYLINE PLACE, 5205, LEESBURG PIKE, SUITE 1404, FALLS CHURCH, VA, 22041, US

(21) Appl. No.: 09/767,747

(22) Filed: Jan. 24, 2001

(51) Int. Cl. B60K 1/00

(52) U.S. Cl. 180/181; 180/65.6

(57) ABSTRACT

An electric wheel axle drive structure with automatic clutch function comprised of a direct current drive motor, a driving worm driven into rotation installed at its front side and upper extent, and a driven shaft disposed perpendicularly at the lower extent of the worm, the rotation of which is transferred to wheels conjoined to its outer lateral ends. Sleeved onto the inner section of the driven gear, having an angle that is the same as the spiral angle of the worm and, furthermore, a teeth face width slightly larger than the shaft width of the worm, constituting a contained-type bevel section enmeshment with it, and receiving its driving force is a bevel gear. At the front extent of the bevel gear is a driving mesh disc having distributed laterally faced, annular-shaped, and bi-directional sloped teeth. Also fixed onto the driven shaft is a driven mesh disc having distributed in an opposite arrangement laterally faced, annular-shaped, and bi-directional sloped teeth such that the forward movement of the driving mesh disc enmesh the two sloped teeth and the driven shaft drives into rotation the wheels at the outer ends. Furthermore, there is a front-end sleeve hole or a pressure plate capable of driving, elastic sleeving, or press fitting at the center section of the driving mesh disc body and at the rear extent is a transverse movement restricting tensile limiter that confines or maintains its enmeshment with the worm throughout the range of leftward and rightward horizontal movement. As such, when the worm is driven, due to the lateral component of force from the similarly angled spiral, this causes the bevel gear to be first immediately swung transversely and moved forward. When the worm is not being driven into rotation, and the wheels are rotated forward or rotated backward, then the driving mesh disc is reversed thrusted to transversely move backward away from the sloped teeth of the driven mesh disc, thereby releasing the enmeshment such that the wheels are not subjected to the drag effect of motor or gear engagement and gently coasts, which is among the innovative features of the invention herein.

### BACKGROUND OF THE INVENTION

1.Field of the Invention

The invention herein relates to an electric wheel axle drive structure with automatic clutch function in which when the motor shaft is not being driven into rotation, and the wheels are rotated forward or rotated backward, since the internal section gear of transfer is automatically released from enmeshment, this allows them to gently coast in an improved drive structure.

2.Description of the Prior Art

Based on environmental protection factors, traffic congestion, health sports, recreation and many other related considerations, conventional fully human powered scooters, bicycles, and other novel vehicles that provide for amusement and exercise are gradually being equipped with rechargeable electric motor driven devices to achieve extended traveling for saving energy, convenience, and increasing recreational interest.

However, an overall review of such electric wheel driving structures now available on the market reveals that the majority rely on chains, belts, or gears assembled to a motor shaft driving gears conjoined to driven wheels; these are simplified in that they are directly driven by motor shafts conjoined to the wheels at their outer faces that rotate.

Since the shaft rotation of such structures consists of gears at their rear extents with which enmeshment is normally maintained, when the motor shaft is not driving rotation, the degree of efficient coasting of the wheels is subjected to the said normal enmeshment, with the pull of magnetic field of the unpowered motor at capacity causing difficulty when the user pushes forward or backward. Also related to this phenomenon, since electric motors have storage battery remaining state of electrical charge problems, if the electricity is completely exhausted or insufficient and there is no means of immediate recharging, the user cannot save energy and efficiently proceed, which proportionately lessens their practicality.

In more complex and expensive vehicle-use electric motor drive structures, the driving gears are either enmeshed with or disengaged from the driven gears in that they have a clutch-capable control structure; the objective is that without switching on and utilizing the motor driving power source, the wheels have gentle coasting suitability. However, such structures are complicated and costly to use and, furthermore, have additionally installed clutch operation extended control structures that are not appropriate for installation on most personal transportation applications (such as scooters, bicycles, and other similar recreational vehicles).

In view of the said simplified structures and the comprehensive demand for automatic clutch operation capability, the inventor of the invention herein conducted extensive research that following numerous testing and improvement culminated in the successful development of the completely practical structure of the invention herein, which is hereby submitted for patent application.

### SUMMARY OF THE INVENTION

The primary objective of the invention herein consists of utilizing a direct current motor driving into rotation a worm that transfers via an enmeshment with a bevel gear at the front side and lower extent and, furthermore, that has the same angle as its spiral angle; furthermore, at the front extent of the bevel gear is a driving mesh disc having distributed laterally faced, annular-shaped, and bi-directional sloped teeth that is coordinated with a driven mesh disc on the said same shaft having an inverse shape such that when the worm is being driven into rotation, this causes the bevel gear to be first immediately swung transversely and automatically moved forward, causing the enmeshment of the driving and the driven mesh discs to drive wheels into forward rotation and advancement; when the worm is not being driven into rotation, and the wheels are rotated forward or rotated backward, since the driven mesh disc is reversed thrusted transversely to move backward away from the driving mesh disc, the enmeshment is automatically released that the wheels are not subjected to the drag effect of motor or gear engagement and gently coasts while saving energy; as such, an additionally installed clutch control device is not required in that the present invention is structurally simple and capable of automatic clutch operation for optimum practicality and efficient operation, which is among its innovative features.

Another objective of the invention herein consists of providing a motor driven worm having a short shaft width such that at the same perpendicular plane of enmeshment, it is capable of enmeshment with a bevel gear at its lower extent; and such that coordinated with the bevel gear on the same shaft is a driving mesh disc along with a driven mesh disc of an inverse shape to achieve the practicality of automatic clutch operation and an innovation having special components in which installation is simple and that economically reduces production cost; furthermore, the present invention is advantageous in that in occupies minimum space, facilitating installation on various personal transportation applications, which is among its innovative features.

Utilizing the structural embodiment of the present invention as installed on a scooter, the brief description of the drawings below are followed by the detailed description of the invention herein.

### BRIEF DESCRIPTION OF THE DRAWINGS

FIG. 1 is an exploded drawing of the invention herein.

FIG. 2 is an isometric drawing of the invention herein.

FIG. 2-A is an isometric drawing of an embodiment of the invention herein.

FIG. 3-A is a cross-sectional drawing of the motor drive utilized in the invention herein.

FIG. 3-B is a cross-sectional drawing of the motor drive utilized in the invention herein.

FIG. 4-A is an orthographic drawing of FIG. 3-A, as viewed from a top perspective.

FIG. 4-B is an orthographic drawing of FIG. 3-B, as viewed from a top perspective.

### DETAILED DESCRIPTION OF THE INVENTION

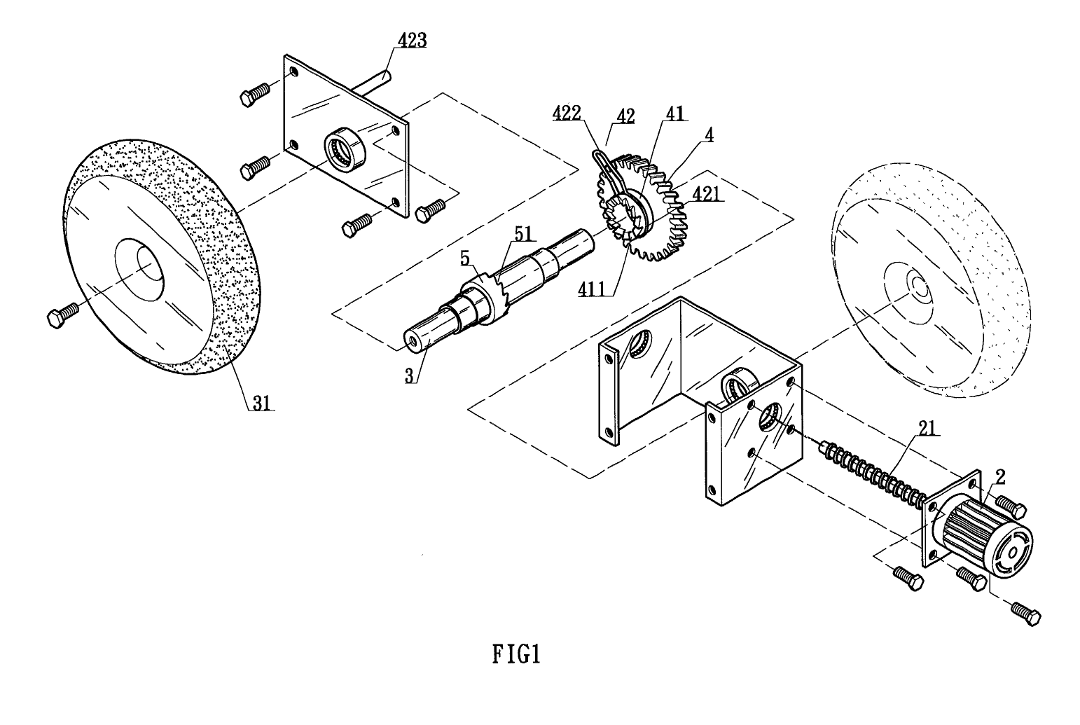

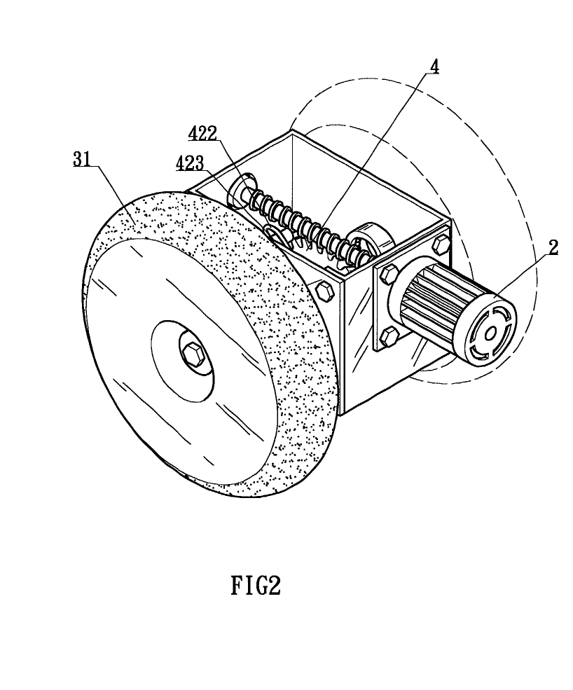

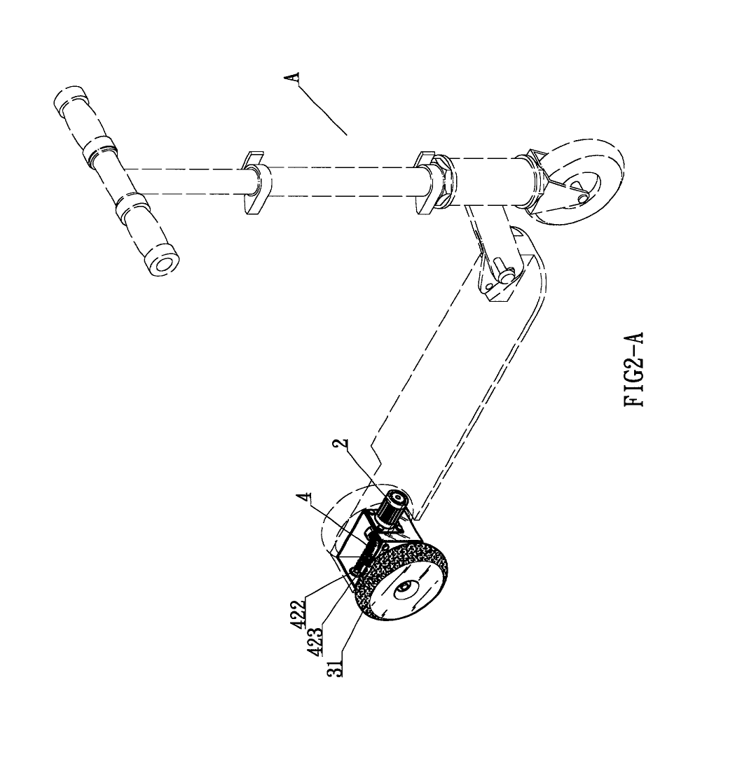

Referring to FIG. 1, FIG. 2, and FIG. 2-A, the invention herein is comprised of:

A worm 21, the rear extent of which is connected to the drive shaft installment end area of a direct current motor 2, with the motor 2 serving as the drive-type mechanism of powered rotation.

A driven shaft 3 disposed perpendicularly at the lower extent of the worm 3; the outer lateral end or two lateral ends of the said driven shaft 3 is attached to a wheels 31 utilized for rolling.

A bevel gear 4 actively sleeved onto the inner section of the driven gear 3; the bevel angle of the said bevel gear 4 is the same as the spiral angle of the worm 21 and, furthermore, its teeth face width is slightly larger than the shaft width of the worm 21 and can be positioned at the lower extent of the worm 21 to constitute a contained-type bevel section enmeshment, such that the bevel gear 4 is limited to either a leftward or a rightward forward movement or backward movement, its stable enmeshment with the worm 21 continuously maintained during the process; wherein at the front extent of the bevel gear 4 and physically of the same body and distributed around the same shaft hole is a driving mesh disc 41 that, furthermore, has laterally faced, annular-shaped, and bidirectional sloped teeth 411; furthermore, there is a front-end sleeve hole (or a pressure plate) 421 capable of driving, elastic sleeving or press fitting on the center section of the driving mesh disc 41 body, and at the rear extent is an extension rod section 422 projecting from a sleeved self-fixing side wall connected stop follower sleeve rod 423 that serves as a tensile limiter 42 that restricts the transverse movement of the bevel gear 4 driving mesh disc 41 by confining or maintaining its enmeshment with the worm 21 throughout the range of leftward and rightward horizontal movement.

A driven mesh disc 5 that is fixed onto the driven shaft 3 and situated at the front extent of the driving mesh disc 4 1; inverse in shape from the sloped face teeth 411 of the driving mesh disc 41, the said driven mesh disc 5 has distributed in an opposite arrangement, laterally faced, annular-shaped, and bidirectional sloped teeth 51; as such, when the driving mesh disc 41 is moved forward, the engagement and enmeshment of the two sloped teeth 411 and 51 cause the wheels 31 at the outer sides of the driven shaft 3 to follow the worm 21 driven by the sloped teeth 4 of the driving mesh disc 41 along with their driven rotation forward.

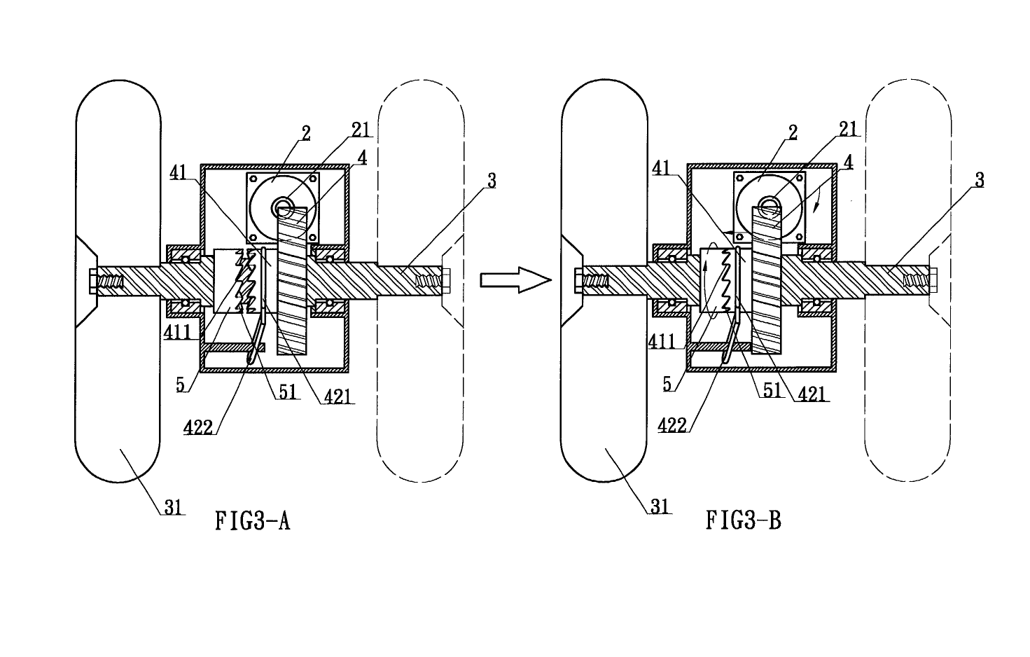

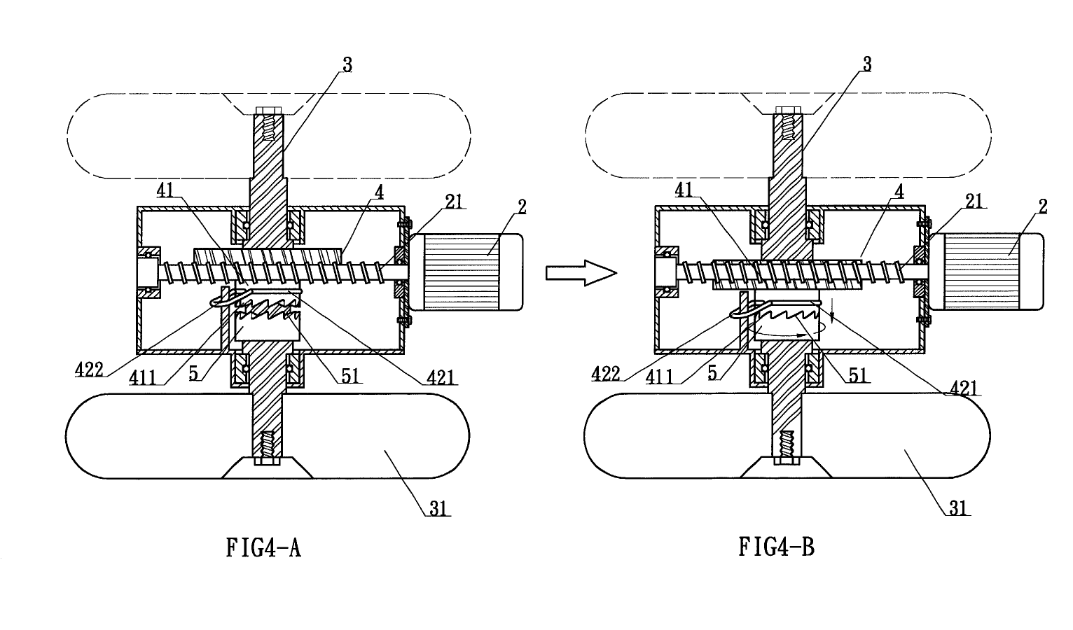

Referring to FIG. 3-A and FIG. 4-A, in the said structure, when the worm 21 is driven in a positive direction, since the bevel angle of the said bevel gear 4 is the same as the spiral angle of the worm 21, the enmeshed drive rotation force is produced simultaneously, and due to the lateral component of force produced by the similarly inclined spiral, this causes the bevel gear 4 to be first immediately driven transversely leftward and automatically move forward, thereby causing the complete engagement and enmeshment of the sloped teeth 411 and 51 of the driving mesh disc 41 and the driven mesh disc 5, respectively, such that the driven shaft 3 and the wheels 31 are driven into forward rotation and advance.

Referring to FIG. 3-B and FIG. 4-B, when the worm 21 is not being driven into rotation, upon the wheels 31 becoming rotated forward or rotated backward as respectively produced by the pushing action of the user on the vehicle body A, since the sloped teeth 51 of the driven mesh disc 5 is impelled by the driven shaft 3, and due to the opposite lateral thrust described in the previous section, the driving mesh disc 41 is reversed thrusted leftward to transversely move backward, thereby releasing the enmeshment; as such, with the driven mesh disc 5 no longer under an enmeshed load and in a state of free rotation, the wheels 31 are not subjected to the drag effect of motor or gear engagement and gently coasts, the user thus saving energy and under conditions of terminated motor drive control having the option of either pushing the vehicle body A or utilizing the existent structural capabilities of the vehicle body A that includes various practical benefits such structural simplicity, low production cost, and minimal space occupance, which are among the major innovative features of the invention herein.

1. An electric wheel axle drive structure with automatic clutch function comprised of:
a worm, the rear extent of which is connected to the drive shaft installment end area of a direct current motor, with the said motor serving as a drive-type mechanism of powered rotation.
a driven shaft disposed perpendicularly at the lower extent of the said worm; the outer lateral end or two lateral ends of the said driven shaft are conjoined to wheels utilized for rolling.
a bevel gear actively sleeved onto the inner section of the said driven shaft; the bevel angle of the said bevel gear is the same as the spiral angle of the said worm and, furthermore, its teeth face width is slightly larger than the shaft width of the said worm and can be positioned at the lower extent of the said worm to constitute a contained-type bevel section enmeshment, such that the said bevel gear is limited to either a leftward or a rightward forward movement or backward movement, its stable enmeshment with the said worm continuously maintained during the process; wherein at the front extent of the said bevel gear and physically of the same body and distributed around the same shaft hole is a driving mesh disc that, furthermore, has laterally faced, annular-shaped, and bi-directional sloped teeth; furthermore, there is a front-end sleeve hole or a pressure plate capable of driving, elastic sleeving or press fitting on the center section of the said driving mesh disc body, and at the rear extent is an extension rod section projecting from a sleeved self-fixed side wall connected stop follower sleeve rod that serves as a tensile limiter that restricts the transverse movement of the said bevel gear driving mesh disc by confining or maintaining its enmeshment with the said worm throughout the range of leftward and rightward horizontal movement.
a driven mesh disc that is fixed onto the said driven shaft and situated at the front extent of the said driving mesh disc; inverse in shape from the said sloped face teeth of the said driving mesh disc, the said driven mesh disc has distributed in an opposite arrangement, laterally faced, annular-shaped, and bi-directional sloped teeth; as such, when the said driving mesh disc is moved forward, the engagement and enmeshment of the two said sloped teeth cause the said wheels at the outer sides of the said driven shaft to follow the said worm driven by the said sloped teeth of the said driving mesh disc along with their driven rotation forward.
in the said structure, when the said worm is driven into rotation, the said bevel gear is first swung horizontally and moved forward, causing the said bevel gear to be first immediately driven transversely leftward and automatically move forward, thereby causing the complete engagement and enmeshment of the said sloped teeth of the said driving mesh disc and the said driven mesh disc, respectively, such that the said wheels are driven into forward rotation and advance; when the said worm is not being driven into rotation, and the said wheels are rotated forward or rotated backward, the said driving mesh disc is reversed thrusted leftward to transversely move backward away from the said sloped teeth of the said driven mesh disc, thereby releasing the enmeshment such that the said wheels are not subjected to the drag effect of motor or gear engagement and gently coasts, which is among the innovative features of the invention herein.
